(19) United States
(12) Patent Application Publication
(10) Pub. No.: US 2026/0177436 A1
(43) Pub. Date: Jun. 25, 2026

(54) PRECISION SHAFT ALIGNMENT FOR HIGH-SPEED ELECTRIC MOTOR AND DYNAMOMETER TESTING

(71) Applicant: HORIBA Instruments Incorporated, Irvine, CA (US)

(72) Inventors: Octavian Musca, Irvine, CA (US); Jeffery A. Kass, Irvine, CA (US)

(21) Appl. No.: 18/999,570

(22) Filed: Dec. 23, 2024

(51) Int. Cl. G01L 3/22

(52) U.S. Cl. CPC G01L 3/22

(57) ABSTRACT

An absorbing dynamometer system enables testing and alignment of electric motors. In one example, the system includes a dynamometer test stand with a front plate and a fixture plate that supports an electric motor, with their major faces in contact. A carriage mounted to the front plate carries an edge surface of the fixture plate and allows vertical and horizontal movement relative to the front plate. Alignment can be achieved using fixture clamps with spring-loaded ball units that press the fixture plate against the front plate. A first actuator moves a wedge within the carriage, enabling vertical adjustment, while a second actuator facilitates horizontal adjustment.

### TECHNICAL FIELD

This disclosure relates to electric motor testing.

### BACKGROUND

An absorbing dynamometer system is a tool used in motor and engine testing to measure the performance and efficiency of devices under test (DUTs), such as electric motors, internal combustion engines, or other rotating machines. Unlike driving dynamometers, which supply power to a system, absorbing dynamometers work by resisting or “absorbing” the rotational energy generated by the DUT. This energy is typically converted into heat or dissipated mechanically, depending on the type of dynamometer. Common types of absorbing dynamometers include eddy current, hydraulic, and electric dynamometers. Eddy current dynamometers, for instance, use magnetic fields to create resistance, while hydraulic dynamometers use fluid to generate resistance through friction. Electric dynamometers, often used in high-precision applications, can regenerate absorbed energy back into the grid. A purpose of an absorbing dynamometer is to provide precise measurements of torque, speed, and power output, while also simulating real-world load conditions.

### SUMMARY

An absorbing dynamometer system is designed for testing and alignment of electric motors. The system includes a dynamometer test stand with a front plate and a fixture plate that supports an electric motor. The fixture plate mounts to the front plate such that their major faces are in contact. A carriage is mounted to the front plate, carrying an edge surface of the fixture plate, and enabling its movement vertically and horizontally relative to the front plate.

A method for aligning a shaft in an absorbing dynamometer system includes installing fixture clamps on the front plate of a dynamometer test stand. Spring-loaded ball units in the clamps press the fixture plate, which supports the electric motor, against the front plate. A first actuator in the carriage moves a wedge, causing a tray and the fixture plate to move vertically relative to the front plate. A second actuator horizontally pushes the fixture plate relative to the front plate.

A dynamometer test stand incorporates a fixture plate designed to support an electric motor and mount to a front plate such that their major faces are in contact. The test stand includes a carriage mounted to the front plate, carrying an edge surface of the fixture plate. The carriage includes a platform, a tray supported by and movable relative to the platform, and an actuator configured to adjust the tray’s position relative to the platform. This allows the fixture plate to move vertically relative to the front plate.

### BRIEF DESCRIPTION OF THE DRAWINGS

FIG. 1 is a perspective view of a specimen part of an absorbing dynamometer system.

FIG. 2 is a detail view of a clamp and vertical/lateral adjustment mechanism of FIG. 1.

FIG. 3A is a detail view of the vertical/lateral adjustment mechanism of FIG. 2.

FIG. 3B is a perspective view, in cross-section, of the clamp and vertical/lateral adjustment mechanism of FIG. 2.

FIG. 3C is a perspective view of portions of the vertical/later adjustment mechanism of FIG. 2.

FIG. 4A is a perspective view of a collet dowel.

FIG. 4B is a side view, in cross-section, of the collet dowel of FIG. 4A and surrounding components of FIG. 1.

FIGS. 5 is a rear detail view of the clamp of FIG. 2.

FIG. 6 is detail view of a support bracket and leveling bushings of FIG. 1.

FIG. 7 is a side view, in cross-section, of a screw with a spherical washer and leveling bushing, and surrounding components of FIG. 1.

### DETAILED DESCRIPTION

Detailed embodiments of the disclosed technology are provided herein. These embodiments, however, are exemplary and the technology may be implemented in various alternative forms. The figures provided are not necessarily drawn to scale. Certain features may be exaggerated or minimized to highlight specific details of particular components. Accordingly, the specific structural and functional details disclosed are not to be interpreted as limiting but rather as illustrative examples intended to provide guidance for those skilled in the art to implement and adapt the technology in different ways.

Electric motor dynamometer test stands, a type of absorbing dynamometer system, are specialized platforms designed to evaluate the performance, efficiency, and durability of electric motors under controlled conditions. These test stands simulate real-world operating environments by applying variable loads to the motor while measuring performance parameters, such as torque, rotational speed, power output, and efficiency. By subjecting electric motors to a range of loads and operating speeds, dynamometer test stands provide data on motor characteristics.

In today’s field of electric motor (e-motor) testing, where rotational speeds can reach 25,000 rpm and higher, precise alignment between the Device Under Test (DUT) (i.e., the e-motor) and the absorbing dynamometer system shaft is of interest. Misalignment can arise from various factors, including manufacturing and assembly tolerances, bearing tolerances, and cumulative dimensional variances in the components. These factors may cause the final position of the DUT shaft to deviate from the theoretical centerline of the rotating axis, leading to horizontal, vertical, or angular misalignment, or a combination of these. Such misalignment can result in increased vibration, excessive wear, and the need for more frequent maintenance.

Horizontal and vertical misalignment can be categorized as either parallel or angular. In parallel misalignment, the specimen shaft remains parallel to the spindle shaft but is offset in either the horizontal or vertical plane. In angular misalignment, the centerline of the specimen shaft forms an angle with the spindle shaft in either the horizontal or vertical plane. Reducing total system misalignment minimizes vibration, wear, and maintenance requirements.

To achieve alignment, the testing process begins by aligning the spindle shaft using an alignment device mounted on the front plate of the test rig. This alignment device employs the same dowels that will later be used to center the DUT so the theoretical shaft axis of the DUT is replicated during alignment. The spindle shaft serves as the central reference point for the entire drivetrain and provides a buffer between the dynamometer and the DUT. All subsequent equipment, including the absorber motor shaft, is aligned to the spindle shaft. After the spindle shaft is aligned, the absorber motor shaft is aligned to it using conventional methods. The final step in the alignment process is to align the DUT shaft to the spindle shaft.

Dynamometer test stands contemplated herein, as discussed in more detail below, are equipped with alignment mechanisms that allow for multi-axis adjustments of the motor mounting platform, enabling corrections for both horizontal and vertical misalignment as well as angular offsets. The specimen motor mounting system, which includes the fixture plate and associated adjustment mechanisms, is designed to hold the motor securely in place while allowing for fine-tuning of its position in relation to the spindle shaft. Vertical, horizontal, and angular adjustment capabilities ensure that the motor is positioned accurately, reducing the risk of vibrational noise, and minimizing measurement inaccuracies.

The load application system, which typically includes an absorbing motor or mechanical brake, applies resistance to the motor under test, simulating the loads it would encounter in real-world applications. Sensors integrated into the test stand, such as torque and speed sensors, are used to directly measure the motor’s output. Additional sensors, such as temperature probes and vibration sensors, may be included to monitor the motor’s thermal and mechanical behavior throughout testing. These sensors feed data into a control system that not only records measurements but also dynamically adjusts load and speed conditions according to predefined test protocols.

For e-motors operating at high speeds, particularly in demanding industrial or automotive applications, the structural stability and vibration resistance of the test stand are of interest. High-strength materials can be used to construct the mounting plates, brackets, and other structural components. Additionally, the test stand may incorporate features to absorb and dissipate vibrational energy.

Several methods exist for detecting shaft misalignment, but correcting it can be challenging, often requiring specialized tools and trained personnel. The innovations described herein introduce equipment and an alignment process for e-motor shafts and high-speed dynamometer test stands. It can be applied to similar applications, offering horizontal and vertical misalignment corrections up to, for example, ±0.18 mm (0.007 in) and angular corrections within the coupling’s angular misalignment limits. Traditionally, fixture plates are located with rigid dowels that have tight tolerances. However, certain embodiments adapt a commercial dowel with a collet feature, commonly used in machining for quick changeovers, to allow for fine adjustments. Using an Allen key and micrometer for initial setup and laser measurement, this dowel can be adjusted to a standard size, and then loosened for on-the-fly alignment corrections, saving time during test setup.

This approach eliminates the uncertainty and trial-and-error methods of previous alignment techniques, which required precisely centered shafts and perpendicular connecting surfaces—helpful for testing at speeds exceeding 15,000 rpm. Any imperfections at these speeds amplify natural and torsional vibrations.

The alignment system relies on a customized adapter plate for the specimen (e.g., e-motor), which is machined to accommodate devices for horizontal, vertical, and angular corrections. This entire process is facilitated by customized collet alignment dowel pins as mentioned previously. Instead of using a traditional headstock, the shaft alignment procedure uses a vertical mounting plate with special features to support the alignment process.

To begin the alignment procedure in one example, the dowel collar is expanded to the specified diameter according to print. The e-motor specimen is then installed onto the test stand front mounting plate using the designated dowel holes. The specimen adapter plate, which is customized for alignment and interface features, serves as the connection between the dynamometer test stand front plate and the e-motor. One half of the coupling—either a rigid bellow or torsionally compliant type for example—is attached to the torque flange rotor, while the other half remains loose on the e-motor shaft. Afterward, the screws securing the e-motor adapter plate to the mounting plate are tightened, and the coupling halves between the spindle and the e-motor are connected.

Next, the laser alignment device, such as a Pruftechnik Optalign system, is installed. The transducer bracket is mounted on the spindle shaft, and the reflector on the e-motor shaft. For accurate measurements, both brackets should be able to swing at least 180°. If the coupling halves are not connected, the Optalign system’s pass mode is activated, allowing the laser brackets to swing successively and take multiple readings. Alignment limits are set based on the system’s maximum speed; for systems exceeding 20,000 rpm, alignment tolerances can be set to 0.04 mm (0.0015 in) for example or better. After setting these limits, alignment values are measured and recorded. If the values for horizontal parallel, horizontal angular, vertical parallel, and vertical angular misalignment fall within the acceptable range, the specimen is ready for testing. Otherwise, alignment correction is performed using other precision shaft alignment processes.

For alignment correction, the laser system is switched to live mode to enable real-time alignment monitoring. The clamping pressure on the adapter plate is loosened, allowing small movements for necessary adjustments. At this stage, the entire specimen assembly with the adapter plate is effectively “suspended” at two points: the vertical adjusting system’s spring-loaded ball units contact corresponding surfaces on the adapter plate. Quick fixture clamps are installed to prevent the assembly from tipping over while maintaining the flexibility needed for plate movement in the vertical plane. The alignment dowel collar is loosened to create clearance for adjustments. Vertical alignment is achieved by turning fine-threaded screws that engage a wedge system, providing precise vertical movement. Horizontal alignment is adjusted by using fine-thread screws to move the adapter plate laterally, within a tolerance of, for example, ±0.18 mm (0.007 in) in both directions.

Angular adjustments are made by turning leveling bushings on the adapter plate, which tilt the plate to correct any misalignment. Because angular adjustments can impact both vertical and horizontal alignment, it is helpful to balance all three factors. All leveling bushings should maintain proper contact with the front plate to avoid a “soft foot” condition, which could result in uneven pressure during tightening. Finally, all screws are tightened in a crisscross pattern, continuously monitoring alignment values to ensure they remain within tolerance.

Once the alignment is complete, a rear bracket is installed to reduce overhung loads, taking care not to alter the alignment. Following these steps achieves precise alignment, minimizing vibrations and equipment wear even at high rotational speeds. The combination of laser alignment and fine mechanical adjustments results in a highly accurate and repeatable process.

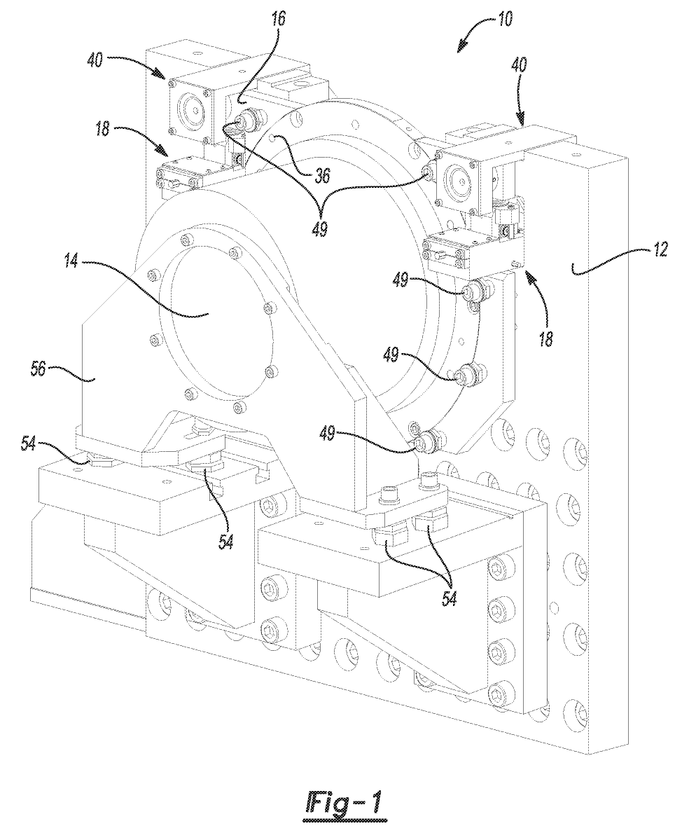

Referring to FIG. 1, a dynamometer test stand 10 includes a front plate 12 mounted to the test stand frame. The front plate 12 is designed to interface with an electric motor specimen 14 for testing. A fixture plate 16 is mounted onto the front plate 12, configured to support the electric motor specimen 14. The fixture plate 16 is positioned such that its major face is in direct contact with the major face of the front plate 12, providing a stable surface-to-surface interface that facilitates alignment and minimizes movement under testing conditions.

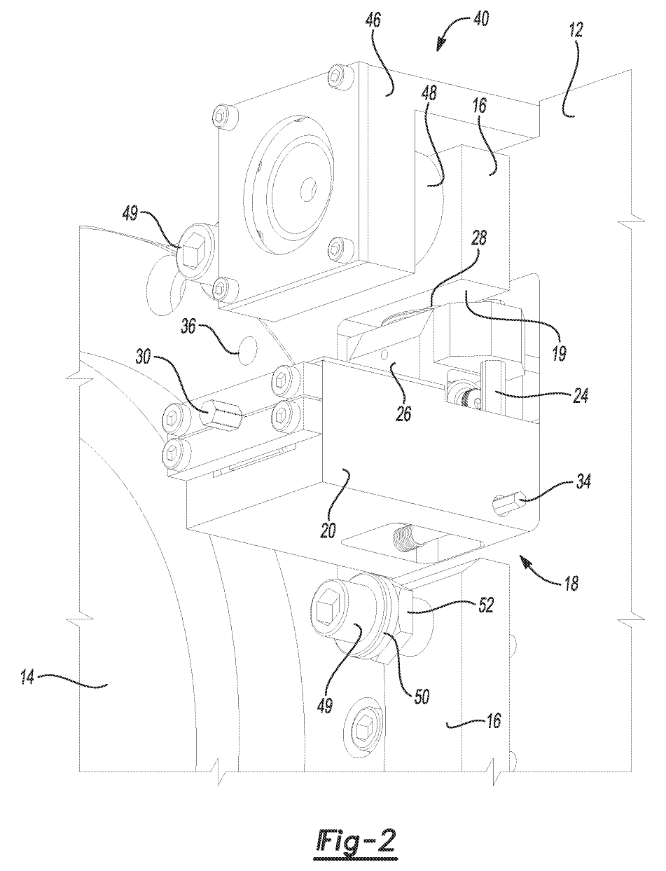

A carriage system 18 is configured along the front plate 12 to support an edge surface 19 (FIG. 2) of the fixture plate 16. The carriage system 18 enables controlled vertical and horizontal movement of the fixture plate 16 relative to the front plate 12. This arrangement allows for precise positioning of the fixture plate 16, thereby supporting accurate alignment of the electric motor specimen 14 with respect to the test stand 10.

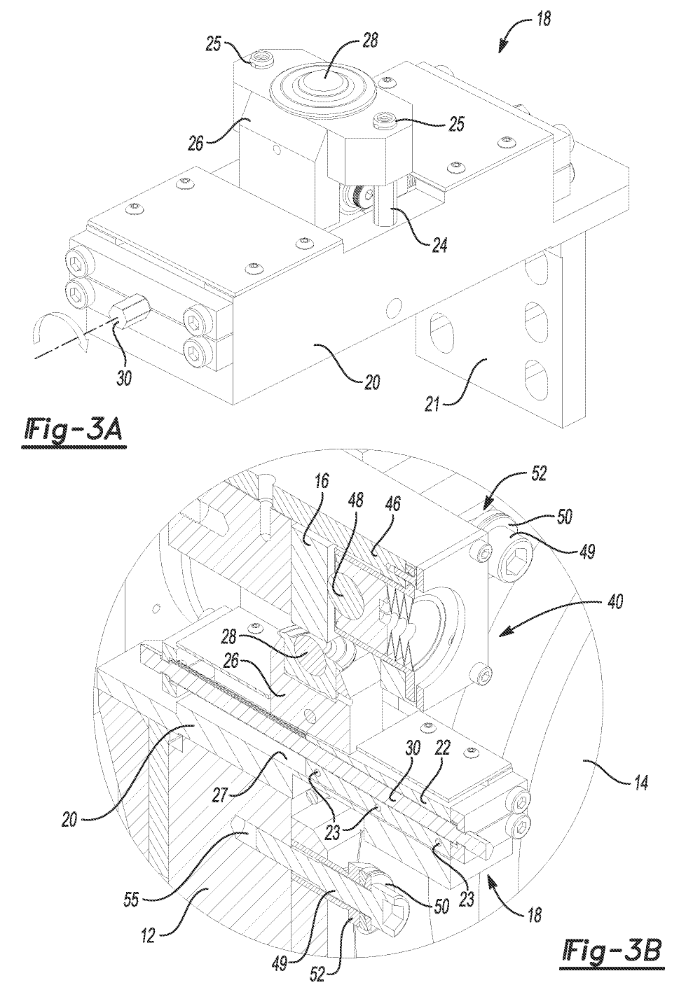

Referring to FIGS. 2, 3A, 3B, and 3C, the carriage system 18 includes a platform 20, which is fixed to the front plate 12 via a bracket 21 and serves as a base for the other components of the carriage system 18. Mounted on the platform 20 is a wedge 22 with cam rollers 23 positioned at a bottom thereof, which provides an inclined plane for the vertical adjustment mechanism. The platform 20 is equipped with guideposts 24, positioned vertically and extending through slotted holes 25 within a tray (block) 26 supported by the wedge 22. The guideposts 24 serve as rails along which the tray 26 can slide vertically in a controlled manner.

The platform 20 further defines a surface 27 underneath the wedge 22 on which the cam rollers 23 move. This enables the tray 26 to be raised or lowered relative to the platform 20 by lateral movement of the wedge 22. The tray 26 includes a rigid ball support 28, which contacts the edge surface 19 of the fixture plate 16. The rigid ball support 28 provides a point of contact that allows the fixture plate 16 to move vertically and laterally with minimal friction when adjustments are made.

An actuator, in this example a threaded screw 30, is operatively connected to the wedge 22. As the threaded screw 30 rotates, it slides the wedge 22 laterally across the surface 27. Due to the cam rollers 23 on the inclined surface of the wedge 22 being in contact with the surface 27 of the platform 20, lateral movement of the wedge 22 causes the tray 26 to move vertically along the guideposts 24. This configuration enables incremental vertical adjustments of the fixture plate 16 relative to the front plate 12, allowing for fine control over the height of the electric motor specimen 14.

In addition to vertical movement, the carriage system 18 is equipped with a second actuator, also a threaded screw 34 in this example, which provides horizontal movement capability for the fixture plate 16 relative to the front plate 12. This threaded screw 34 is positioned perpendicular to the guideposts 24 and interfaces with the fixture plate 16. By rotating the actuator 34, the operator can laterally push the fixture plate 16 via the opposite end of the actuator 34, aligning the electric motor specimen 14 in the horizontal direction.

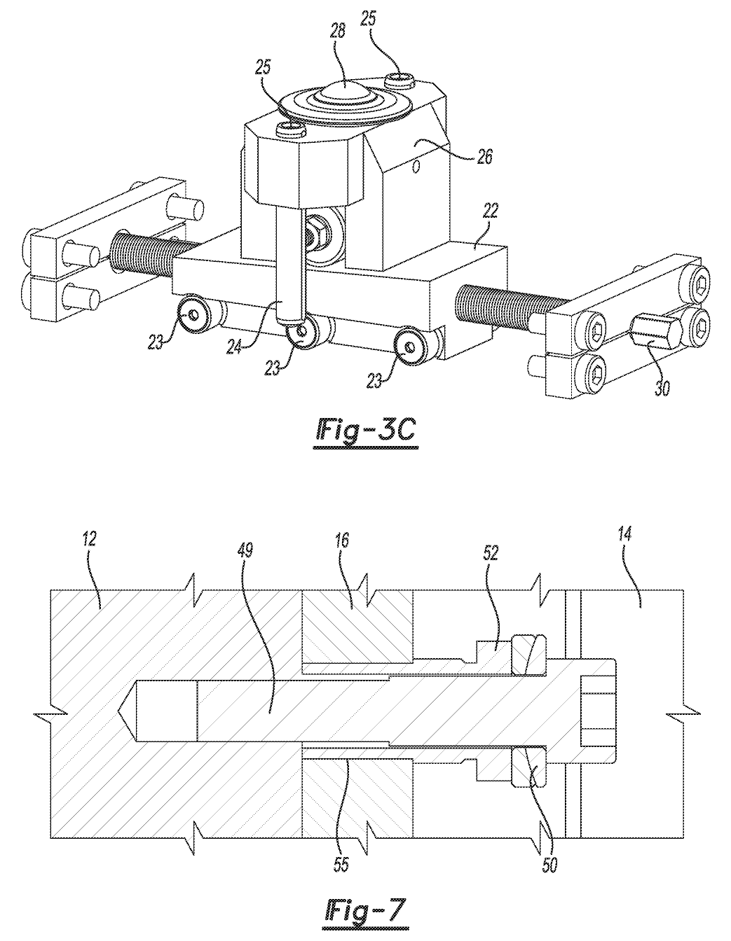

Referring to FIGS. 4A and 4B, the front plate 12 and fixture plate 16 include bore holes 36, which are dimensioned to receive collet-equipped dowels 38. During assembly, the fixture plate 16 is inserted onto the collet part of the dowels 38 through the bore holes 36. The collet-equipped dowels 38 are configured to secure the fixture plate 16 to the front plate 12 once alignment is achieved. The dowels 38 provide a precise fit through the bore holes 36, maintaining the fixture plate 16 in its aligned position. The collet mechanism within each of the dowels 38 adds additional holding force to enhance the stability of the connection between the fixture plate 16 and the front plate 12 under testing loads.

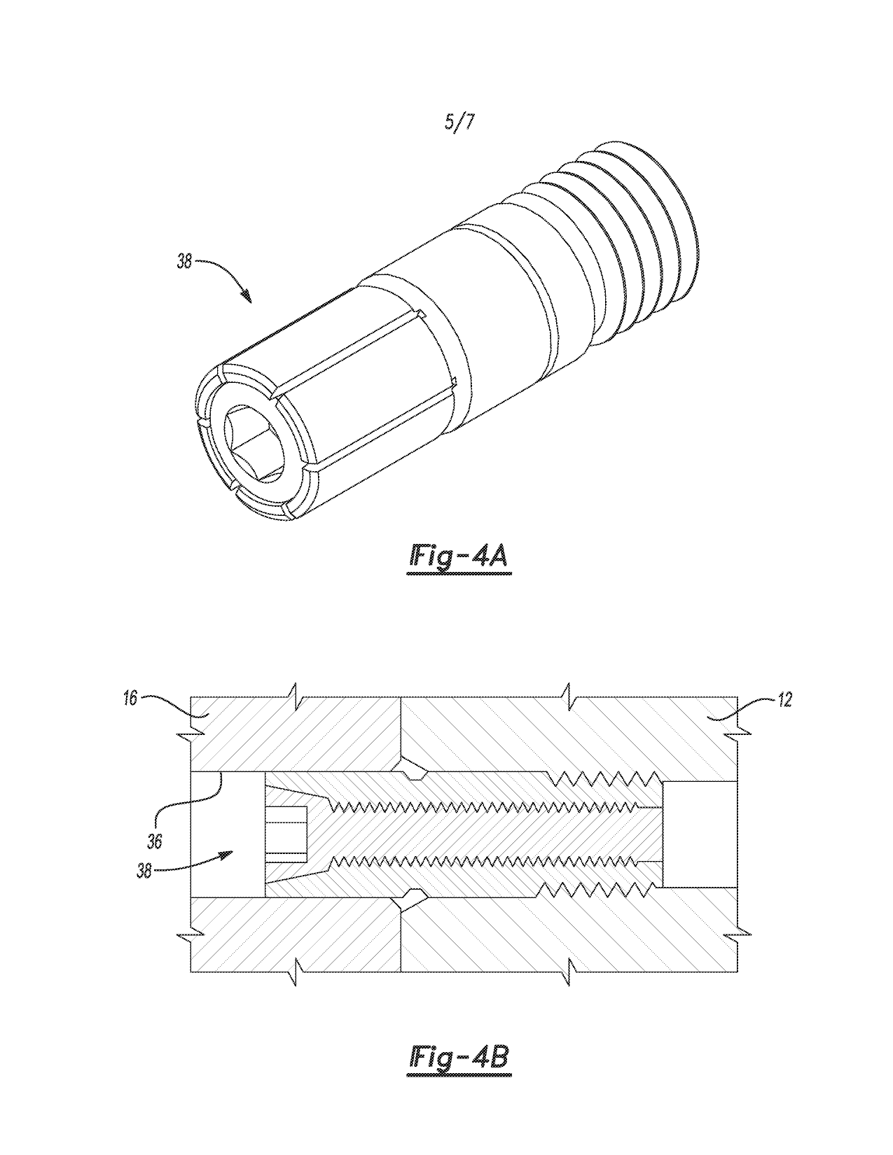

Referring to FIGS. 2 and 5, a bracket assembly 40 is mounted to a top of the front plate 12 via shoulder and holdings screws 42, 44, and designed to apply clamping force to hold the fixture plate 16 firmly against the front plate 12. The bracket assembly 40 includes a clamp arm 46 that extends over the edge of the fixture plate 16 and a spring loaded roller ball 48, allowing it to press the fixture plate 16 into stable contact with the front plate 12. The clamping force applied by the bracket assembly 40 secures the fixture plate 16 to the front plate 12 during alignment operations.

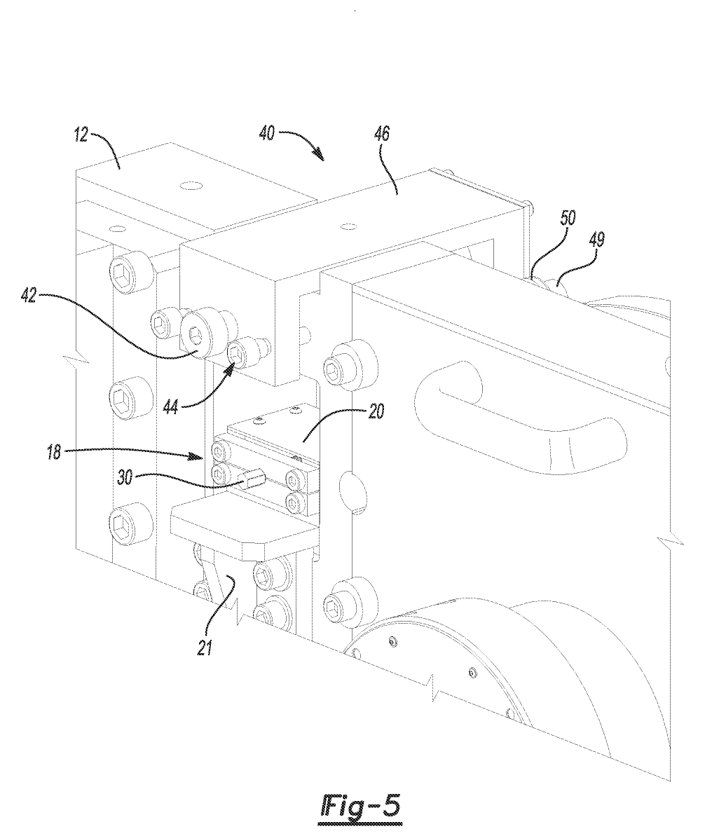

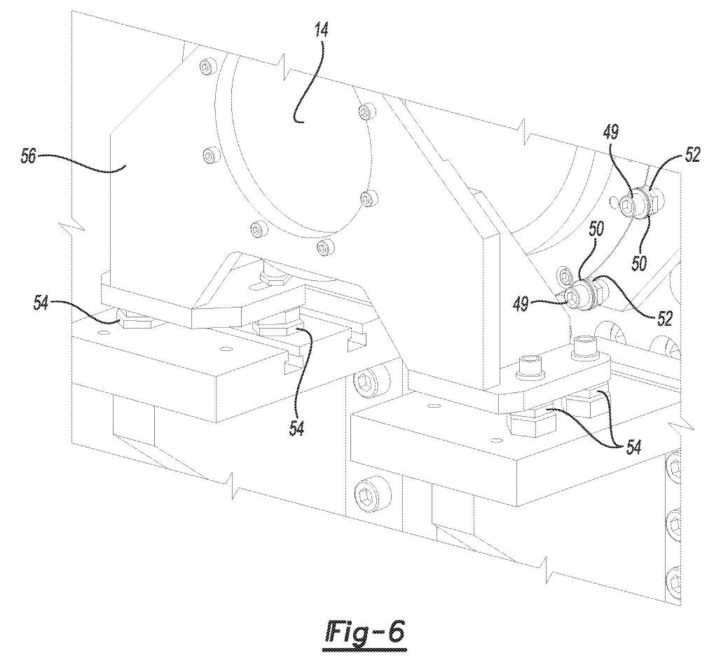

Referring to FIGS. 6 and 7, to facilitate angular alignment of the fixture plate 16 relative to the front plate 12, a set of angular adjustment components is provided. This set includes screws 49 with spherical washers 50 and leveling bushings 52, and leveling bushings 54. The screws 49 are positioned within bores 55 of the front plate 12 and fixture plate 16. The spherical washers 50 and leveling bushings 52 allow the screws 49 to pivot slightly, accommodating minor angular adjustments.

The leveling bushings 54 are positioned beneath a support bracket 56 for the electric motor specimen 14 and are configured to eliminate “soft foot” conditions on the bottom surface of the rear supporting e-motor bracket. By providing stable contact and allowing controlled adjustments, the leveling bushings 54 help maintain the final position of the electric motor specimen 14. Adjusting the height or tilt of the leveling bushings 54 enables the operator to align the support bracket 56 accurately, ensuring proper angular alignment and preventing uneven loading or deformation during operation.

The dynamometer test stand 10 uses a combination of the carriage system 18, collet-equipped dowels 38, bracket 40, and angular adjustment components 49, 50, 52, 54 to achieve precise positioning and secure attachment of the fixture plate 16 to the front plate 12. The carriage system 18, through the platform 20, wedge 22, tray 26, guideposts 24, and actuators 30 and 34, allows for controlled vertical and horizontal adjustments. This arrangement facilitates the alignment of the electric motor specimen 14 in both vertical and horizontal directions.

Once the fixture plate 16 is aligned, the screws 49, as well as other screws, are used to lock the fixture plate 16 in place, preventing relative movement between the fixture plate 16 and the front plate 12. The bracket 40 applies additional clamping force during adjustment to prevent the fixture plate 16 from falling away from the front plate 12. Angular adjustments are achieved by the angular adjustment components 49, 50, 52, 54, allowing for tilting adjustments of the fixture plate 16 to ensure alignment of the electric motor specimen 14.

While exemplary embodiments have been described above, these embodiments are not intended to represent all possible implementations of the disclosed technology. The terminology used in this specification serves as descriptive language rather than as limitations. It is understood that various modifications and adaptations can be made without departing from the scope and underlying principles of the disclosed technology. Furthermore, the features of different embodiments may be combined in various ways to create additional implementations.

What is claimed is:

1. An absorbing dynamometer system comprising:
a dynamometer test stand including a front plate, a fixture plate configured to support an electric motor and mount to the front plate such that major faces of the front plate and fixture plate are in contact with each other, and a carriage, mounted to the front plate such that the carriage carries an edge surface of the fixture plate, configured to move the fixture plate vertically and horizontally relative to the front plate.

2. The absorbing dynamometer system of claim 1, wherein the carriage includes a platform, a wedge on the platform, a tray on the wedge having a ball support in contact with the edge surface, and an actuator configured to slide the wedge over the platform and under the tray to move the ball support vertically relative to the front plate.

3. The absorbing dynamometer system of claim 2, wherein the platform includes guideposts and the tray defines slotted holes configured to slide along the guideposts.

4. The absorbing dynamometer system of claim 2, wherein the tray defines a surface in contact with the wedge.

5. The absorbing dynamometer system of claim 2, wherein the actuator is a threaded screw.

6. The absorbing dynamometer system of claim 1, wherein the carriage includes an actuator configured to horizontally slide the fixture plate relative to the front plate.

7. The absorbing dynamometer system of claim 6, wherein the actuator is a threaded screw.

8. The absorbing dynamometer system of claim 1, wherein the front plate defines bore holes, further comprising collet-equipped dowels configured to secure the fixture plate to the front plate via the bore holes.

9. The absorbing dynamometer system of claim 1 further comprising a bracket mounted to the fixture plate and configured to clamp the fixture plate against the front plate.

10. The absorbing dynamometer system of claim 1 further comprising a plurality of screws, spherical washers, and leveling bushings mounting the fixture plate to the front plate and configured to permit angular movement of the fixture plate relative to the front plate.

11. A method for aligning a shaft of an absorbing dynamometer system, comprising:
installing fixture clamps on a front plate of a dynamometer test stand such that spring-loaded ball units of the fixture clamps press a fixture plate supporting an electric motor against the front plate;
actuating a first actuator of a carriage mounted to the front plate to move a wedge of the carriage such that a tray of the carriage and the fixture plate moves vertically relative to the front plate; and
actuating and second actuator of the carriage to horizontally push the fixture plate relative to the front plate.

12. The method for aligning a shaft of an absorbing dynamometer system of claim 11, wherein the actuating a first actuator includes turning a threaded screw.

13. The method for aligning a shaft of an absorbing dynamometer system of claim 11, wherein the actuating a second actuator includes turning a threaded screw.

14. A dynamometer test stand comprising:
a fixture plate configured to support an electric motor and mount to a front plate such that major faces of the front plate and fixture plate are in contact with each other; and
a carriage mounted to the front plate and configured to carry an edge surface of the fixture plate, the carriage including a platform, a tray supported by, and movable relative to, the platform, and an actuator configured to adjust a position of the tray relative to the platform to move the fixture plate vertically relative to the front plate.

15. The dynamometer test stand of claim 14, wherein the carriage further includes a wedge disposed between the platform and tray and wherein the actuator is configured to adjust the position via movement of the wedge.

16. The dynamometer test stand of claim 15, wherein the carriage includes cam rollers arranged with the wedge and in contact with the platform.

17. The dynamometer test stand of claim 14, wherein the tray includes a ball support in contact with the edge surface.

18. The dynamometer test stand of claim 14, wherein the carriage includes guideposts and the tray defines slotted holes configured to slide along the guideposts.
